(19) United States
(12) Patent Application Publication
(10) Pub. No.: US 2022/0156375 A1
(43) Pub. Date: May 19, 2022

(54) DETECTION OF REPEATED SECURITY EVENTS RELATED TO REMOVABLE MEDIA

(71) Applicant: Saudi Arabian Oil Company, Dhahran (SA)

(72) Inventor: Michael Bradford Gilliam, Dhahran (SA)

(73) Assignee: Saudi Arabian Oil Company, Dhahran (SA)

(21) Appl. No.: 16/950,371

(22) Filed: Nov. 17, 2020

(51) Int. Cl. G06F 21/56; G06F 16/14

(52) U.S. Cl. CPC G06F 21/565; G06F 2221/034; G06F 16/152; G06F 21/566

(57) ABSTRACT

Systems and computer-implemented methods described herein are related to identifying, a computer-related security event that is related to a removable media device, and a user account associated with the security event; determining, by the at least one processor based on the identification of the user account, a number of previous computer-related security events that are associated with the user account; and outputting, by the at least one processor, an indication of the security event, an indication of the user account, and an indication of the number of previous computer-related security events that are associated with the user account. Other embodiments may be described or claimed.

### BACKGROUND

### Technical Field

The present disclosure applies to the identification and mitigation of repeated security events related to removable media.

### Background

The uncontrolled use of removable media may increase the risk of malware being transferred to critical business systems. However, using removable media may be viewed as necessary in some organizations, and therefore banning the use of such media outright may have a significant negative impact on productivity.

### SUMMARY

The present disclosure describes techniques that can be used for quickly and accurately detecting repeat instances of a security event related to removable media, thereby enabling remediation of the one or more security events.

In some implementations, a computer-implemented method includes identifying, by at least one processor of an electronic device, a computer-related security event that is related to a removable media device, and a user account associated with the security event. The method further includes determining, by the at least one processor based on the identification of the user account, a number of previous computer-related security events that are associated with the user account. The method further includes outputting, by the at least one processor, an indication of the security event, an indication of the user account, and an indication of the number of previous computer-related security events that are associated with the user account.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this disclosure can be implemented in particular implementations, so as to realize one or more advantages. In some organizations, there may be over 500,000 security-related events each day. This volume of events may make it difficult to process them accurately and in a timely fashion. For example, the identification and processing of such events may not be a simple black and white determination, but rather may require correlation of multiple layers to make the determination that the event is potentially malicious and fits the criteria of interest. Additionally, analysis of an event in a timely manner may be desirable, because a delay in analysis may allow for repeated unaddressed malicious events to occur. By contrast, embodiments herein relate to timely and accurate detection of malicious security events related to removable media so that some form of remedial action may be taken. As such, the negative consequences of such events may be mitigated.

The details of one or more implementations of the subject matter of this disclosure are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 depicts a technique for the identification and mitigation of security events related to removable media, in accordance with various embodiments.

FIG. 2 depicts a technique for the identification of security threat information related to a security event, in accordance with various embodiments.

FIG. 3 depicts a technique for the identification of account information related to a security event, in accordance with various embodiments.

FIG. 4 depicts an alternative technique related to the identification and mitigation of security events related to removable media, in accordance with various embodiments.

FIG. 5 depicts a block diagram illustrating an example computer system used to provide computational functionalities associated with described algorithms, methods, functions, processes, flows, and procedures as described in the present disclosure, in accordance with various embodiments.

FIG. 6 depicts an example table with information related to various security events, in accordance with various embodiments.

Like reference numbers and designations in the various drawings indicate like elements.

### DETAILED DESCRIPTION

The following detailed description describes techniques for the identification and mitigation of security events in a computer system. Specifically, embodiments may relate to security events that are related to the use of removable media in the computer system. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

As used herein, the term “removable media” relates to a form of computer storage that is designed to be inserted and removed from an electronic device. For example, “removable media” may include an optical disc, a compact disc (CD), a CD-read only memory (CD-ROM) or some other form of media which requires a reader to be installed in or connected to the electronic device. In other embodiments, the “removable media” may be or include a device such as a flash drive that may be communicatively coupled with the electronic device through a universal serial bus (USB) port of the electronic device or some other type of port. In other embodiments the removable media may be some other type of removable media.

As used herein, the term “computer system” or “computing system” relate to a system of one or more electronic devices. For example, the computing system may include only a single electronic device (e.g., a laptop, a workstation, a personal computer, etc.) In another example, the computing system may include a plurality of electronic devices that are networked together such that information may be transmitted between two or more of the plurality of electronic devices. In some embodiments, each of the electronic devices may be in a same general location as one another (e.g., the same office, the same building, etc.) while in other embodiments one or more of the electronic devices may be remote from another of the electronic devices.

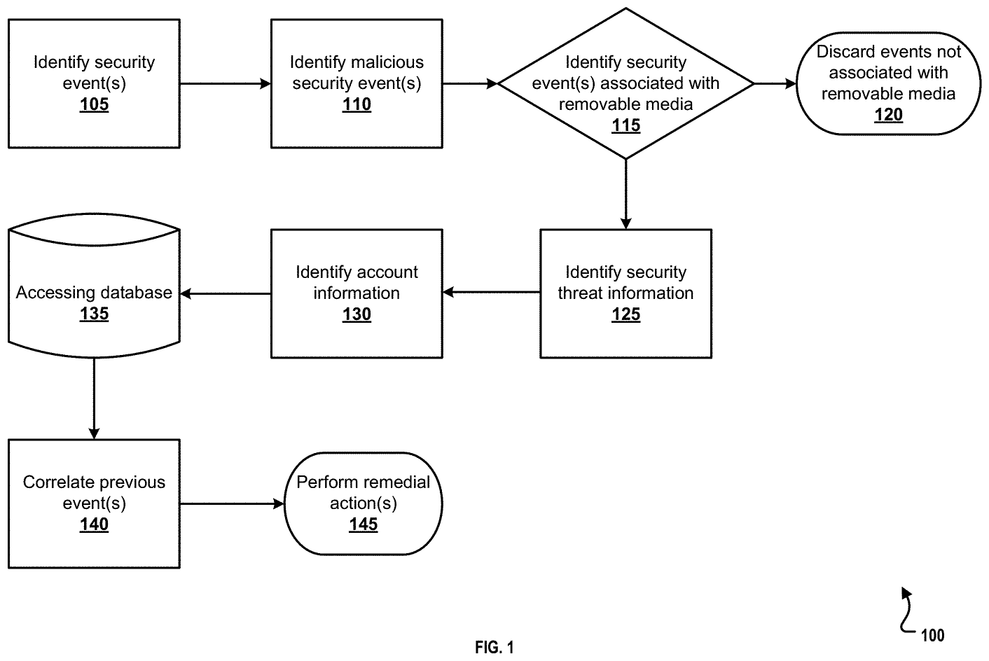

FIGS. 1, 2, 3, and 4 depict example techniques related to the identification and mitigation of security events related to removable media, in accordance with various embodiments. For clarity of presentation, the description that follows generally describes the techniques in the context of the other FIGS. in this description. However, it will be understood that various of the techniques may be performed, for example, by any suitable system, environment, software, and hardware, or a combination of systems, environments, software, and hardware, as appropriate. For example, in some embodiments one or more of the elements of the techniques of FIGS. 1-4 may be performed by a processor such as processor 505. In some implementations, various steps of the techniques can be run in parallel, in combination, in loops, or in any order. Some embodiments may include more or fewer elements than are depicted. For example, some of the depicted elements may be combined with one another in some embodiments. Other variations may be present in other embodiments.

FIG. 1 depicts a technique 100 for the identification and mitigation of security events related to removable media, in accordance with various embodiments. The technique may include identifying, at 105, one or more security events. As used herein, a “security event” may relate to attempted or actual unauthorized access, use, disclosure, modification, or destruction of information in a computer system. For example, in some embodiments, each security event that occurs in the computing system may be logged in one or more databases. The security event may include, for example, an individual entering a wrong password, an individual accessing or copying a file or directory to which they are not supposed to have access, deletion or modification of a directory or file, or some other type of security event. Generally, what qualifies as a “security event” may be based on factors such as the type or organization which is performing the technique 100, specific events of interest to the organization, or some other factor.

In some embodiments, each security event may be analyzed in accordance with the technique 100 of FIG. 1. Specifically, as a security event is detected, then the security event may be analyzed as follows. In another embodiment, security events (and information associated with them) may be stored, for example in a database or some form of other log, and then a group of security events is analyzed in accordance with the technique 100 of FIG. 1. For example, in some embodiments logged security events may be analyzed once an hour, once a day, once a week, etc. Generally, the time frame in which the security events are analyzed may be based on factors such as the number of security events that occur within the computing system, the desired speed with which an organization that uses the computing system wishes to analyze the security events, or other factors.

When a security event occurs, various data related to the security event may be logged. For example, data such as a type of security event (e.g., incorrect password, file or directory destruction, installation of malware, etc.) may be logged. Additional information such as a user identifier (ID) associated with the security event, a computer ID associated with the security event, a time/date/location of the security event, a source of the security event (e.g., removable media or some other type of source), or other information may be logged. For example, this information may be stored in a database of the computing system in a format such as a table, a directory format, a spreadsheet, or some other type of format. When the security event(s) are identified at 100, the identification may include identification of one or more of these pieces of information for further processing, as described below.

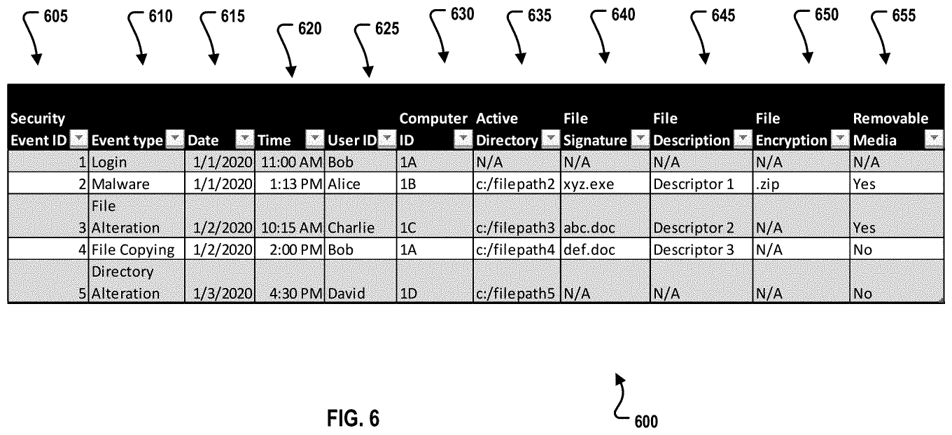

FIG. 6 depicts an example table 600 showing information related to various types of security events. In some embodiments, this table 600 may be an element of the log of security events described above. That is, the table 600 may be generated and updated as new security events are logged, or as security events are processed in accordance with the technique of FIG. 1. It will be understood that the table 600 is intended as a simplified high-level example of such a table 600, and other embodiments may have more or fewer entries, entries in a different order, etc. It will also be understood that the table of FIG. 6 is depicted in a human-displayable or manipulable form for the sake of presentation and discussion herein, however in other embodiments the table may not be accessible by a human because one or more of the techniques of FIG. 1, 2, 3, or 4 are performed by one or more processors of an electronic device.

The table 600 may include a number of entries, as shown. Entry 605 relates to an ID of a security event. Specifically, each security event in the table 600 may have a unique ID. Entry 610 relates to a type of the security event. As shown, each security event may relate to a type of actions, as described above. Entries 615 and 620 relate to the date and time at which the security event occurred or was logged. The table 600 may further include an indication of an active directory which was affected by the security event. Such an affect may include whether a file in the directory, or the directory itself, was accessed, copied, modified, deleted, etc.

In some embodiments, the table 600 may further include information related to a file description at 645 and a description of the file encryption at 650. For example, the file description may include entries that relate to the status of the file or actions that have been taken. Such entries may include data such as:
Malware deleted
file infected. Undetermined clean error, deleted successfully
file infected. Undetermined clean error, denied access and continued
file infected. Delete failed, denied access and continued

It will be understood that the above described entries are intended as non-limiting example. Other embodiments may include other possible descriptions or entries related to analysis or actions taken with respect to the subject files.

The file encryption 650 may include an indicator of whether the file was encrypted and, if so, which technique was used to encrypt the file. The table 600 may further include an indication of whether the security event was related to the use of removable media.

As may be seen in table 600, not every security event may have a corresponding entry in every column of the table 600. For example, if the security event relates to a login attempt or a directory alteration, then elements such as “file signature,” “file description,” etc. may not include a corresponding entry. It will also be understood that the specific entries or descriptors used in the depiction of table 600 are intended as example entries, and other embodiments may include an entry in a different format such as a hash or some other indicator which may include data related to the security event.

The technique 100 may then include identifying malicious security events at 110. Specifically, the security events identified at 105 may be narrowed to identify a subset of the security events that are malicious security events. As used herein, a malicious security event may relate to a security event that is a threat to the computing system. Such a malicious security event may relate to, for example, the installation of malware, damage to a file or directory, or some other type of event. It will be understood that the term “malicious security event” is not limited to only events that are performed with malicious intent, but rather relate to events that have a negative result on the network. For example, an individual may insert a removable flash drive into a USB slot of a computing system, allowing malware to infect the system, but the individual may be unaware of the malware. In this situation, such an event may be identified as a malicious security event, even if the intent of the individual was not necessarily negative.

Generally, the identification of the malicious security events at 110 may be based on identification of the type of security event using, for example, column 610 in table 600. For example, certain “types” of security events (e.g., file/directory alteration or destruction, installation of malware, etc.) may be pre-identified as “malicious,” and so identification of malicious security events may be based on identification of security events with certain types or tags.

The technique 100 may further include identifying, at 115, security events associated with removable media. For example, for the security events identified at 105 or 110, each of the security events may be reviewed to identify security events that are associated with the use of removable media using, for example, column 655 of table 600 as described above. Events that are not associated with removable media may be discarded at 120.

Generally, the events may be identified at 115 based on a number of factors. For example, a file path related to a file associated with the security event may be reviewed to identify whether the file path indicates whether the file originated from or is otherwise associated with removable media. In some embodiments, this element may include comparison of the file path with information related to a configuration file of the electronic device, which may indicate whether the media from which the file originated is removable media. As another example, a timestamp related to the security event may be compared to a timestamp associated with removable media being inserted into or removed from a computing system of the network. If the two timestamps are relatively close to one another, then the security event may be flagged as being associated with removable media. Other factors may be present in other embodiments.

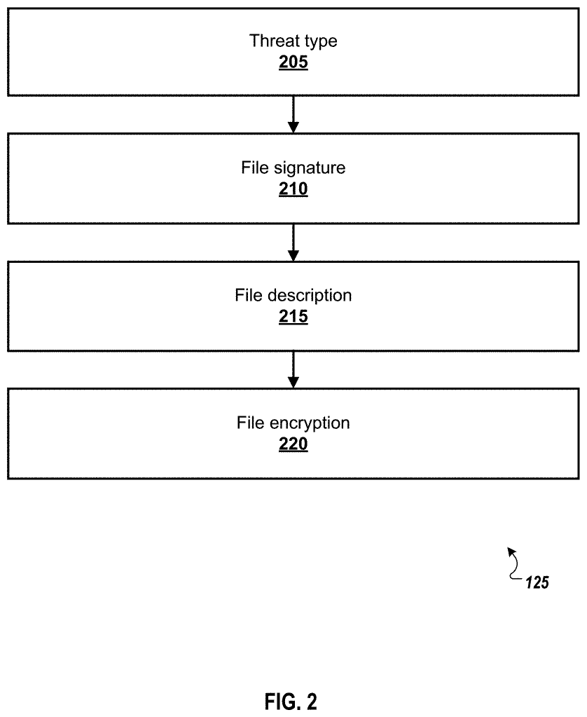

The technique 100 may further include identifying, at 125, security threat information related to one or more of the security events that have been identified at one or more of elements 105, 110, and 115. An example technique for the identification of the security threat information is described at, for example, FIG. 2.

In some embodiments, this may include some elements of the information identified at 110 as described above. For example, this information may already be identified at element 110. In other embodiments, this element may include review of one or more databases or tables such as table 600 to identify the elements of FIG. 2.

Specifically, identifying the security threat information at 125 may include identifying the threat type related to the security event at 205 based on, for example, column 610 of table 600. Identifying the security threat information at 125 may further include identifying information related to the file signature at 210 based on, for example, column 640 of table 600. Identifying the security threat information at 125 may further include identifying information related to the file description at 215 based on, for example, column 645 of table 600. Identifying the security threat information at 125 may further include identifying information related to the file encryption at 220 based on, for example, column 650 of table 600. In some embodiments, identifying the security threat information at 125 may further include more or fewer elements than are depicted in FIG. 2.

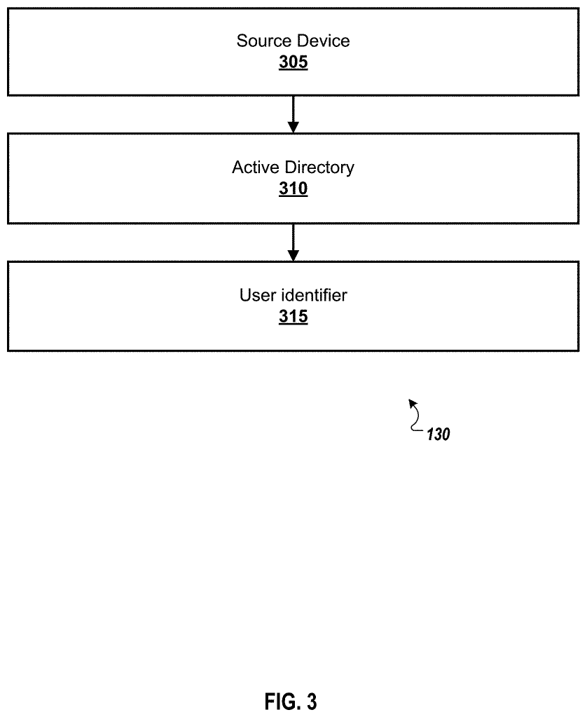

The technique 100 may further include identifying, at 130, account information related to one or more of the security events that have been identified at one or more of elements 105, 110, and 115. FIG. 3 depicts an example technique for the identification of account information related to a security event, in accordance with various embodiments. Specifically, identifying the account information at 130 may include identifying the source device at 305 based on, for example, column 630 of table 600. Identifying the account information at 130 may further include identifying the active directory at 310 based on, for example, column 635 of table 600. Identifying the account information at 130 may further include identifying a user ID at 315 based on, for example, column 625 of table 600. In some embodiments, identifying the account information at 130 may further include more or fewer elements than are depicted in FIG. 3.

The technique 100 may further include accessing a database at 135. In some embodiments, accessing the database 135 may include storing information related to one or more security events in the database. For example, element 105, 110, 115, 125, and 130 may relate to a security event that had recently occurred. The information gathered at each of those steps may be from a transitory or temporary storage, or a different storage. As the information is gathered, it may be desirable to store it in a database at 135. The format of the database may be similar to, for example, the format of table 600, or some other format. In this manner, a historical record of the security events of the computer system may be created.

Accessing the database at 135 may additionally or alternatively further include identifying one or more previous security events that share an element of one or more of the security events identified at 105, 110, or 115. Specifically, the database may be reviewed at 135 to identify previous security events that are associated with a user ID that is associated with one or more of the security events identified at 105, 110, or 115. To put it another way, the database is accessed at 135 to identify previous security events that are associated with a user that has been identified at element 130. In this way, repeated instances of security events associated with a user may be identified at correlated at 140. Based on this correlation, one or more remedial actions may be performed at 145.

In some embodiments, the remedial action(s) performed at 145 may include a change in user permissions or access with respect to the computing system or portions of the computing system. In some embodiments, the remedial action(s) performed at 145 may include outputting an indication of some or all of the information related to the user or the security event such that a human (e.g., a manager, an information technologies (IT) specialist, a human resources (HR) manager, a law enforcement officer, etc.) may take a remedial action such as discussing the event with the repeat offender. Other actions may additionally or alternatively be performed based on the identification of repeated occurrence of security events.

In some embodiments, the remedial action(s) performed at 145 may include outputting information related to the security event such as an indication of information related to the security event, an indication of the user account associated with the security event, and an indication of the number of previous computer-related security events that are associated with the user account. The indications related to these elements may take a variety of forms that are able to be interpreted by a human or another algorithm or program. Examples of such indications may include a user ID, a hash related to the user, an email address or name of the user, the date or time of the security event, the type of security event, etc. In some embodiments, a report may be generated and output which may include one or more of these pieces of information.

In some embodiments, performance of the remedial action, or the type of remedial action that is to be performed, may be based on a number of security-events identified at 140. For example, the number of total (or previous) security-events associated with a user ID may be identified at 140. If the number is not above (or, at or above) a threshold value, then no remedial action may be taken. Alternatively, a different remedial action (e.g., different types of access restriction or alteration of account permission) may occur based on whether the number of previous events is above (or, at or above) the threshold. In some embodiments, the threshold may be pre-identified, while in other embodiments the threshold may be dynamic and identified based on, for example, a time period over which the events occurred, other events in the system, an access level related to the user account, etc.

As previously noted, the technique of FIG. 1 may provide the advantage of enabling timely and accurate detection of malicious security events related to removable media so that some form of remedial action may be taken. As such, the negative consequences of such events may be mitigated. Specifically, the technique of FIG. 1 may allow for the timely and accurate identification of an individual that is related to, or the cause of, repeated security events. By identifying this individual, an organization may be able to take one or more remedial actions that will prevent the individual from being associated with further security events, thereby mitigating the negative consequences of such events. Additionally or alternatively, systemic issues related to the security events may be identified such that remedial actions may be taken system-wide to reduce or otherwise mitigate the occurrence of further security events.

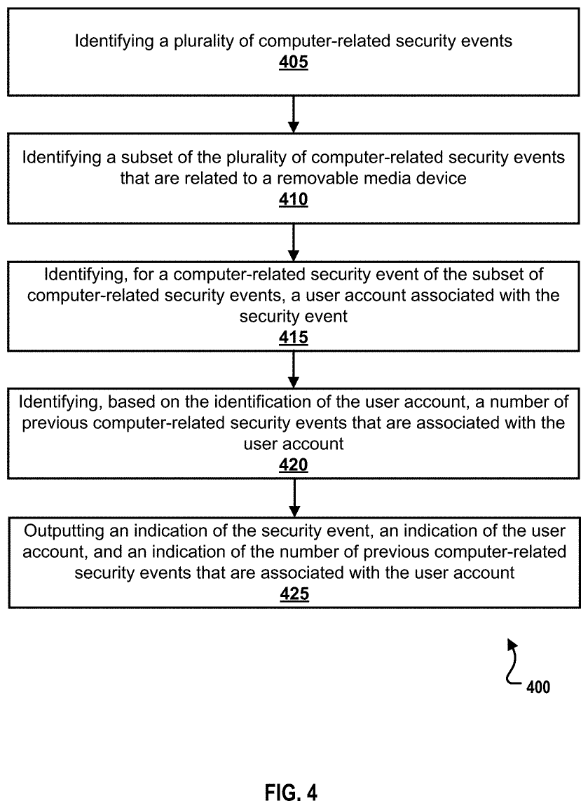

FIG. 4 depicts an alternative technique 400 related to the identification and mitigation of security events related to removable media, in accordance with various embodiments. The technique 400 includes identifying, at 405, a plurality of computer-related security events. Identification of the security events at 405 may be similar to, and share one or more characteristics with, the identification of security events at 105 or the identification of one or more malicious security events at 110.

The technique 400 may further include identifying, at 410, a subset of the plurality of computer-related security events that are related to a removable media device. Identification of the subset at 410 may be similar to, and share one or more characteristics with, the identification performed at 115.

The technique 400 may further include identifying, at 415, for a computer-related security event of the subset of computer-related security events (that were identified at 410), a user account associated with the security event. Identification of the user account at 415 may be similar to, for example, element 130 of FIG. 1 or, more specifically, element 315 of FIG. 3.

The technique 400 may further include identifying, at 420 based on the identification of the user account, a number of previous computer-related security events that are associated with the user account. This identification may be similar to, for example, the correlation described above with respect to element 140 based on accessing the database at 135.

The technique 400 may further include outputting, at 425, an indication of the security event, an indication of the user account, and an indication of the number of previous computer-related security events that are associated with the user account. Such an output may be similar to, for example, the output described above with respect to element 145.

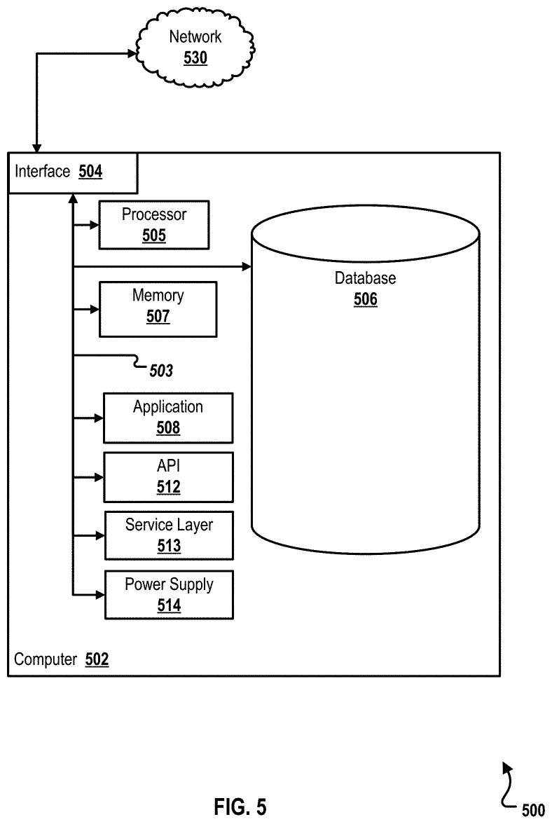

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a computer-implemented method includes identifying, by at least one processor of an electronic device, a computer-related security event that is related to a removable media device, and a user account associated with the security event; determining, by the at least one processor based on the identification of the user account, a number of previous computer-related security events that are associated with the user account; and outputting, by the at least one processor, an indication of the security event, an indication of the user account, and an indication of the number of previous computer-related security events that are associated with the user account.

The foregoing and other described implementations can each, optionally, include one or more of the following features:

In a first feature, which may be combinable with one or more other features described herein, the method further includes identifying, by the at least one processor of the electronic device, that the computer-related security event is related to the removable media device based on a file path of a file associated with the computer-related security event or a timestamp of the computer-related security event.

In a second feature, which may be combinable with one or more other features described herein, the method further comprises determining the number of previous computer-related security events based on a database that stores information related to previous computer-related security events.

In a third feature, which may be combinable with one or more other features described herein, the method further comprises outputting, by the at least one processor, a report that includes the indication of the security event, the indication of the user account, and the indication of the number of previous-computer-related security events.

In a fourth feature, which may be combinable with one or more other features described herein, the method further comprises identifying the computer-related security event based on a log that is related to a plurality of computer-related security events.

In a fifth feature, which may be combinable with one or more other features described herein, identifying the user account is based on at least one of a user identifier (ID), a hash related to the user ID, and an identifier of a computer associated with the user ID.

In a sixth feature, which may be combinable with one or more other features described herein, the method further includes identifying, by the at least one processor, the computer-related security event based on a file signature or a file descriptor related to the computer-related security event.

In a seventh feature, which may be combinable with one or more other features described herein, the method further includes outputting, by the at least one processor, the indication of the security event, the indication of the user account, and the indication of the number to a non-transitory computer-readable storage media that is communicatively coupled with the at least one processor.

In an eighth feature, which may be combinable with one or more other features described herein, the method further includes altering, by the processor based on a security event type or the number of previous computer-related security events, a user access permission related to the user account.

In a ninth feature, which may be combinable with one or more other features described herein, the method further includes outputting, by the processor, the indication of the security event, the indication of the user account, and the indication of the number of previous computer-related security events if the number of previous computer-related security events is at or above a threshold value.

In a tenth feature, which may be combinable with one or more other features described herein, the threshold value is based on the user account, the number of previous computer-related security events, or a type of the security event.

In a second implementation, at least one non-transitory computer-readable media includes instructions that, upon execution of the instructions by at least one processor of an electronic device, are to cause the electronic device to: identify, for a computer-related security event related to use of a removable media device, a user account associated with the security event; determine, based on the identification of the user account, a number of previous computer-related security events that are associated with the user account; and output an indication of the security event, an indication of the user account, and an indication of the number of previous computer-related security events that are associated with the user account.

The foregoing and other described implementations can each, optionally, include one or more of the following features:

In a first feature, which may be combinable with one or more other features described herein, the instructions are to identify the user account based on at least one of a user identifier (ID), a hash related to the user ID, and an identifier of a computer associated with the user ID.

In a second feature, which may be combinable with one or more other features described herein, the instructions are further to identify the computer-related security event based on a file signature or a file descriptor related to the computer-related security event.

In a third feature, which may be combinable with one or more other features described herein, the instructions are further to alter, based on a security event type or the number of previous computer-related security events, a user access permission related to the user account.

In a fourth feature, which may be combinable with one or more other features described herein, the instructions are further to output the indication of the security event, the indication of the user account, and the indication of the number of previous computer-related security events based on a comparison of the number of previous computer-related security events to a threshold value.

In a third implementation, an electronic device includes at least one processor; and at least one non-transitory computer-readable media comprising instructions that, upon execution of the instructions by the at least one processor, are to cause the electronic device to: identify a plurality of computer-related security events; identify a subset of the plurality of computer-related security events that are related to a removable media device; identify, for a computer-related security event of the subset of computer-related security events, a user account associated with the security event; identify, based on the identification of the user account, a number of previous computer-related security events that are associated with the user account; and output an indication of the security event, an indication of the user account, and an indication of the number of previous computer-related security events that are associated with the user account.

The foregoing and other described implementations can each, optionally, include one or more of the following features:

In a first feature, which may be combinable with one or more other features described herein, the instructions are to identify the user account based on at least one of a user identifier (ID), a hash related to the user ID, and an identifier of a computer associated with the user ID.

In a second feature, which may be combinable with one or more other features described herein, the instructions are further to identify a computer-related security event of the plurality of computer-related security events based on a file signature or a file descriptor related to the computer-related security event.

In a third feature, which may be combinable with one or more other features described herein, the instructions are further to alter, based on a security event type or the number of previous computer-related security events, a user access permission related to the user account.

Implementations of the subject matter and the functional operations described in this disclosure can be implemented in digital electronic circuitry, in tangibly embodied computer software or firmware, in computer hardware, including the structures disclosed herein and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this disclosure can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a USB flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of UI elements, some or all associated with a web browser, such as interactive fields, pull-down lists, and buttons. These and other UI elements can be related to or represent the functions of the web browser.

Implementations of the subject matter described in this disclosure can be implemented in a computing system that includes a back-end component, for example, as a data server, or that includes a middleware component, for example, an application server. Moreover, the computing system can include a front-end component, for example, a client computer having one or both of a graphical user interface or a web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this disclosure contains many specific implementation details, these should not be construed as limitations on the scope of what may be claimed, but rather as descriptions of features that may be specific to particular implementations. Certain features that are described in this disclosure in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A method comprising:
identifying, by at least one processor of an electronic device, a computer-related security event that is related to a removable media device, and a user account associated with the security event;
determining, by the at least one processor based on the identification of the user account, a number of previous computer-related security events that are associated with the user account; and
outputting, by the at least one processor, an indication of the security event, an indication of the user account, and an indication of the number of previous computer-related security events that are associated with the user account.

2. The method of claim 1, wherein the method further comprising identifying, by the at least one processor of the electronic device, that the computer-related security event is related to the removable media device based on a file path of a file associated with the computer-related security event or a timestamp of the computer-related security event.

3. The method of claim 1, wherein the method further comprises determining the number of previous computer-related security events based on a database that stores information related to previous computer-related security events.

4. The method of claim 1, wherein the method further comprises outputting, by the at least one processor, a report that includes the indication of the security event, the indication of the user account, and the indication of the number of previous-computer-related security events.

5. The method of claim 1, wherein the method further comprises identifying the computer-related security event based on a log that is related to a plurality of computer-related security events.

6. The method of claim 1, wherein identifying the user account is based on at least one of a user identifier (ID), a hash related to the user ID, and an identifier of a computer associated with the user ID.

7. The method of claim 1, further comprising identifying, by the at least one processor, the computer-related security event based on a file signature or a file descriptor related to the computer-related security event.

8. The method of claim 1, further comprising outputting, by the at least one processor, the indication of the security event, the indication of the user account, and the indication of the number to a non-transitory computer-readable storage media that is communicatively coupled with the at least one processor.

9. The method of claim 1, wherein the method further comprising altering, by the processor based on a security event type or the number of previous computer-related security events, a user access permission related to the user account.

10. The method of claim 1, wherein the method further comprises outputting, by the processor, the indication of the security event, the indication of the user account, and the indication of the number of previous computer-related security events if the number of previous computer-related security events is at or above a threshold value.

11. The method of claim 10, wherein the threshold value is based on the user account, the number of previous computer-related security events, or a type of the security event.

12. At least one non-transitory computer-readable media comprising instructions that, upon execution of the instructions by at least one processor of an electronic device, are to cause the electronic device to:
identify, for a computer-related security event related to use of a removable media device, a user account associated with the security event;
determine, based on the identification of the user account, a number of previous computer-related security events that are associated with the user account; and
output an indication of the security event, an indication of the user account, and an indication of the number of previous computer-related security events that are associated with the user account.

13. The at least one non-transitory computer-readable media of claim 12, wherein the instructions are to identify the user account based on at least one of a user identifier (ID), a hash related to the user ID, and an identifier of a computer associated with the user ID.

14. The at least one non-transitory computer-readable media of claim 12, wherein the instructions are further to identify the computer-related security event based on a file signature or a file descriptor related to the computer-related security event.

15. The at least one non-transitory computer-readable media of claim 12, wherein the instructions are further to alter, based on a security event type or the number of previous computer-related security events, a user access permission related to the user account.

16. The at least one non-transitory computer-readable media of claim 12, wherein the instructions are further to output the indication of the security event, the indication of the user account, and the indication of the number of previous computer-related security events based on a comparison of the number of previous computer-related security events to a threshold value.

17. An electronic device comprising:
at least one processor; and
at least one non-transitory computer-readable media comprising instructions that, upon execution of the instructions by the at least one processor, are to cause the electronic device to:
identify a plurality of computer-related security events;
identify a subset of the plurality of computer-related security events that are related to a removable media device;
identify, for a computer-related security event of the subset of computer-related security events, a user account associated with the security event;
identify, based on the identification of the user account, a number of previous computer-related security events that are associated with the user account; and
output an indication of the security event, an indication of the user account, and an indication of the number of previous computer-related security events that are associated with the user account.

18. The electronic device of claim 17, wherein the instructions are to identify the user account based on at least one of a user identifier (ID), a hash related to the user ID, and an identifier of a computer associated with the user ID.

19. The electronic device of claim 17, wherein the instructions are further to identify a computer-related security event of the plurality of computer-related security events based on a file signature or a file descriptor related to the computer-related security event.

20. The electronic device of claim 17, wherein the instructions are further to alter, based on a security event type or the number of previous computer-related security events, a user access permission related to the user account.
